(19) United States
(12) Patent Application Publication
(10) Pub. No.: US 2011/0173744 A1
(43) Pub. Date: Jul. 21, 2011

(54) SANITARY WASHING APPARATUS

(75) Inventors: Shintaro Fukuzato, Fukuoka-ken (JP); Yukihiro Kozono, Fukuoka-ken (JP); Shinichi Koso, Fukuoka-ken (JP)

(73) Assignee: TOTO LTD., Kitakyushu-shi (JP)

(21) Appl. No.: 13/005,653

(22) Filed: Jan. 13, 2011

(30) Foreign Application Priority Data
Jan. 15, 2010 (JP) 2010-007439

(51) Int. Cl. A61H 35/00

(52) U.S. Cl. 4/443

(57) ABSTRACT

A sanitary washing apparatus includes a washing nozzle configured to discharge wash water toward a human body part, the washing nozzle including: a water supply path configured to pass the wash water; an orifice configured to direct the wash water passed through the water supply path toward the human body part; a throat provided on a trajectory connecting the orifice and the human body part; a mixing chamber provided on a downstream side of the orifice and on an upstream side of the throat, an area of a cross section of the mixing chamber perpendicular to a discharge direction of the wash water being larger than an area of a cross section of the orifice perpendicular to the discharge direction; and an air intake portion configured to take air into the mixing chamber by a negative pressure generated by wash water flowing from the orifice toward the throat, a return flow being generated in the mixing chamber by wash water flowing out from the orifice and having a flow direction changed by a wall face of the mixing chamber, the air sucked into the mixing chamber via the air intake portion being mixed into the return flow as an air bubble, the return flow mixed with the air joining wash water flowing from the orifice toward the throat and being discharged from the throat.

### CROSS-REFERENCE TO RELATED APPLICATIONS

This application is based upon and claims the benefit of priority from the prior Japanese Patent Application No. 2010-007439, filed on Jan. 15, 2010; the entire contents of which are incorporated herein by reference.

### BACKGROUND

1. Field of the Invention

Embodiments described herein relate generally to a sanitary washing apparatus, and specifically to a sanitary washing apparatus that uses water to wash the bottom and the like of a user sitting on a sit-down toilet stool.

2. Background Art

It is considered that a washing method that achieves both a feeling of stimulation and a feeling of volume by wash water, for example, is good in order to enhance the feeling of washing in a sanitary washing apparatus. To intensify the feeling of stimulation, it is necessary, for example, to increase the flow speed of discharged water, to cause discharged water to hit a part of a human body without decreasing the increased flow speed in the flow path, and the like.

Methods for increasing the flow speed of discharged water include, for example, narrowing the diameter of the washing flow path, increasing the flow speed compulsorily with a pump, and the like. On the other hand, methods for causing discharged water to hit a part of a human body without decreasing the increased flow speed in the flow path include, for example, providing an orifice portion and a throat portion so that the human body part may exist on a locus connecting the orifice portion and the throat portion, and the like (JP-A 2002-167844 and JP-A 2002-188202).

Methods for increasing the feeling of volume include, for example, making the exit area of the throat portion larger than the entry area to generate oscillation in discharged water to discharge wash water to a wider area of a part of a human body.

However, the apparatuses described in JP-A 2002-167844 and JP-A 2002-188202 require a larger amount of wash water. Therefore, it is necessary for the sanitary washing apparatus to include a warm-water tank with a larger volume in order to enable to discharge warm water even in the case of being used over longer periods of time or the case of being used continuously. This requires a larger amount of electricity in order to heat the water in the warm-water tank, leading to increased standby power of the warm-water tank. This may impede energy saving.

In contrast, energy saving can be accomplished in the case where, for example, the sanitary washing apparatus is provided with not a warm-water tank but an instantaneous-heating heat exchanger that can heat supplied water instantaneously into prescribed warm water. However, as described above, there may be cases where the instantaneous-heating heat exchanger cannot be used in the case where a larger amount of wash water is needed. This is because there are limitations on the flow rate at which the instantaneous-heating heat exchanger can generate warm water. For example, when water having a flow rate exceeding the warm-water generation capacity of the instantaneous-heating heat exchanger is supplied, the water supplied is not heated sufficiently at the instantaneous-heating heat exchanger. This may cause temperature unevenness in the generated warm water or make it impossible to generate prescribed warm water.

### SUMMARY

According to an aspect of the invention, there is provided a sanitary washing apparatus including a washing nozzle configured to discharge wash water toward a human body part, the washing nozzle including: a water supply path configured to pass the wash water; an orifice configured to direct the wash water passed through the water supply path toward the human body part; a throat provided on a trajectory connecting the orifice and the human body part; a mixing chamber provided on a downstream side of the orifice and on an upstream side of the throat, an area of a cross section of the mixing chamber perpendicular to a discharge direction of the wash water being larger than an area of a cross section of the orifice perpendicular to the discharge direction; and an air intake portion configured to take air into the mixing chamber by a negative pressure generated by wash water flowing from the orifice toward the throat, a return flow being generated in the mixing chamber by wash water flowing out from the orifice and having a flow direction changed by a wall face of the mixing chamber, the air sucked into the mixing chamber via the air intake portion being mixed into the return flow as an air bubble, the return flow mixed with the air joining wash water flowing from the orifice toward the throat and being discharged from the throat.

### BRIEF DESCRIPTION OF THE DRAWINGS

FIG. 1 is a schematic perspective view illustrating a toilet system including a sanitary washing apparatus according to an embodiment of the invention;

FIG. 2 is a schematic plan view of an end of a washing nozzle of the embodiment as viewed from side;

FIG. 3 is a schematic plan view of the end of the washing nozzle of the embodiment as viewed from a direction of arrow A illustrated in FIG. 2;

FIG. 4 is a schematic cross-sectional view illustrating the inner structure of the washing nozzle of the embodiment;

FIG. 5 is a schematic cross-sectional view illustrating the inner structure of the washing nozzle of the embodiment;

FIG. 6 is a schematic cross-sectional view for describing the flow of wash water in the washing nozzle of the embodiment;

FIG. 7 is a schematic cross-sectional view for describing the flow of wash water in a washing nozzle according to a variation of the embodiment; and

FIG. 8 is a photograph illustrating an example of the wash water discharged from the washing nozzle of the embodiment.

### DETAILED DESCRIPTION

A first invention is a sanitary washing apparatus including a washing nozzle configured to discharge wash water toward a human body part, the washing nozzle including: a water supply path configured to pass the wash water; an orifice configured to direct the wash water passed through the water supply path toward the human body part; a throat provided on a trajectory connecting the orifice and the human body part; a mixing chamber provided on a downstream side of the orifice and on an upstream side of the throat, an area of a cross section of the mixing chamber perpendicular to a discharge direction of the wash water being larger than an area of a cross section of the orifice perpendicular to the discharge direction; and an air intake portion configured to take air into the mixing chamber by a negative pressure generated by wash water flowing from the orifice toward the throat, a return flow being generated in the mixing chamber by wash water flowing out from the orifice and having a flow direction changed by a wall face of the mixing chamber, the air sucked into the mixing chamber via the air intake portion being mixed into the return flow as an air bubble, the return flow mixed with the air joining wash water flowing from the orifice toward the throat and being discharged from the throat.

According to this sanitary washing apparatus, the wash water flowing toward the entry of the throat is divided into wash water that passes through the throat and wash water whose flow direction is changed by the wall face of the mixing chamber. A return flow is produced by the wash water whose flow direction is changed by the wall face of the mixing chamber. A negative pressure is generated in the mixing chamber by the return flow and the wash water flowing from the orifice toward the throat. Accordingly, the air outside the washing nozzle is sucked into the mixing chamber via the air intake portion. As a consequence, the air sucked into the mixing chamber is mixed into the return flow as air bubbles and flows along with the return flow. The return flow mixed with the air joins the wash water flowing from the orifice toward the throat and is discharged from the throat.

Thereby, a lot of air can be mixed into wash water jetted out from the throat toward a human body part. This can increase water-saving efficiency. Since water-saving efficiency can be increased, electric power for heating the water in a warm-water tank, for example, can be reduced to decrease standby power more. Therefore, energy saving can be accomplished.

A second invention is the sanitary washing apparatus according to the first invention, in which a repetition of increase and decrease in pressure is caused in the mixing chamber by a negative pressure generated by wash water flowing from the orifice toward the throat and the air sucked into the mixing chamber via the air intake portion.

According to this sanitary washing apparatus, a repetition of a high-speed portion and a low-speed portion is caused in wash water discharged from the washing nozzle due to the repetition of increase and decrease in pressure in the mixing chamber. In other words, a speed difference is caused between points of the wash water discharged from the washing nozzle. The speed difference gives rise to a repetition of condensation and rarefaction of the wash water as a natural variation. The speed difference of the wash water forms liquid drops in the wash water discharged from the washing nozzle.

Therefore, the portion of liquid drops of wash water can land on a human body part, allowing to provide a feeling of volume. Furthermore, when the portion of liquid drops of wash water lands on a human body part, the human body part has a larger load. This can provide a feeling of stimulation. Therefore, a feeling of washing can be maintained even if the flow rate of wash water is reduced, while increasing water-saving efficiency and reducing standby power.

A third invention is the sanitary washing apparatus according to the first invention, in which the orifice and the throat are provided in an end portion of the mixing chamber as viewing a cross section perpendicular to the discharge direction of the wash water.

According to this sanitary washing apparatus, since the orifice and the throat are provided in an end portion of the mixing chamber as viewing a cross section perpendicular to the discharge direction of wash water, wash water flowing from the orifice toward the throat passes through the end portion of the mixing chamber. Since a larger space in which the return flow is produced is ensured, the return flow is formed larger in the mixing chamber. Accordingly, pieces of the air mixed in with the return flow come into contact with each other less readily and are kept in a fine state. Consequently, the air sucked into the mixing chamber and the return flow are mixed together more efficiently. Therefore, more air is mixed into the return flow.

A fourth invention is the sanitary washing apparatus according to the first invention, in which the air intake portion is provided in a position away from the orifice and the throat.

According to this sanitary washing apparatus, the air sucked into the mixing chamber is mixed into the return flow with limited influence of disorder of the jet flow of wash water flowing from the orifice toward the throat. Accordingly, the air sucked into the mixing chamber is mixed into the return flow in a more stable state. Consequently, the air sucked into the mixing chamber and the return flow are mixed together more efficiently. Therefore, more air is mixed into the return flow.

A fifth invention is the sanitary washing apparatus according to the first invention, in which the air intake portion is formed to run along a flow of the return flow, and the air sucked via the air intake portion flows into the mixing chamber to run along the flow of the return flow.

According to this sanitary washing apparatus, since the air to be sucked into the mixing chamber is sucked and flows to run along the flow of the return flow, the air flows into the mixing chamber more efficiently and is mixed into the return flow more efficiently. Therefore, more air is mixed into the return flow.

A sixth invention is the sanitary washing apparatus according to the first invention, in which the mixing chamber has a shape configured to reduce attenuation of wash water including the air.

According to this sanitary washing apparatus, since the mixing chamber has a shape configured to reduce attenuation of the return flow, the flow of the return flow is easily maintained and is less likely to become slow. As a consequence, the air sucked into the mixing chamber and the return flow are mixed together yet more efficiently. Therefore, yet more air is mixed into the return flow.

A seventh invention is the sanitary washing apparatus according to the first invention, in which a narrowing projection configured to narrow the flow path area of the throat is provided at the throat.

According to this sanitary washing apparatus, since the narrowing projection configured to narrow the flow path area of the throat is provided at the throat, the flow of water mixed with air and exiting from the mixing chamber generates a negative pressure in the throat after passing the narrowing projection of the throat. The negative pressure causes a repeated movement of the flow of water being drawn to the inner wall of the throat. Thereby, water discharged from the throat is discharged while oscillating with a central focus on the discharge direction of the water. Therefore, the discharged water can be turned into a droplet state at early stage, allowing to provide a high feeling of stimulation. Furthermore, the oscillation can extend the washing area.

Embodiments of the invention will now be described with reference to the drawings. In the drawings, similar components are marked with like reference numerals, and a detailed description thereof is omitted as appropriate.

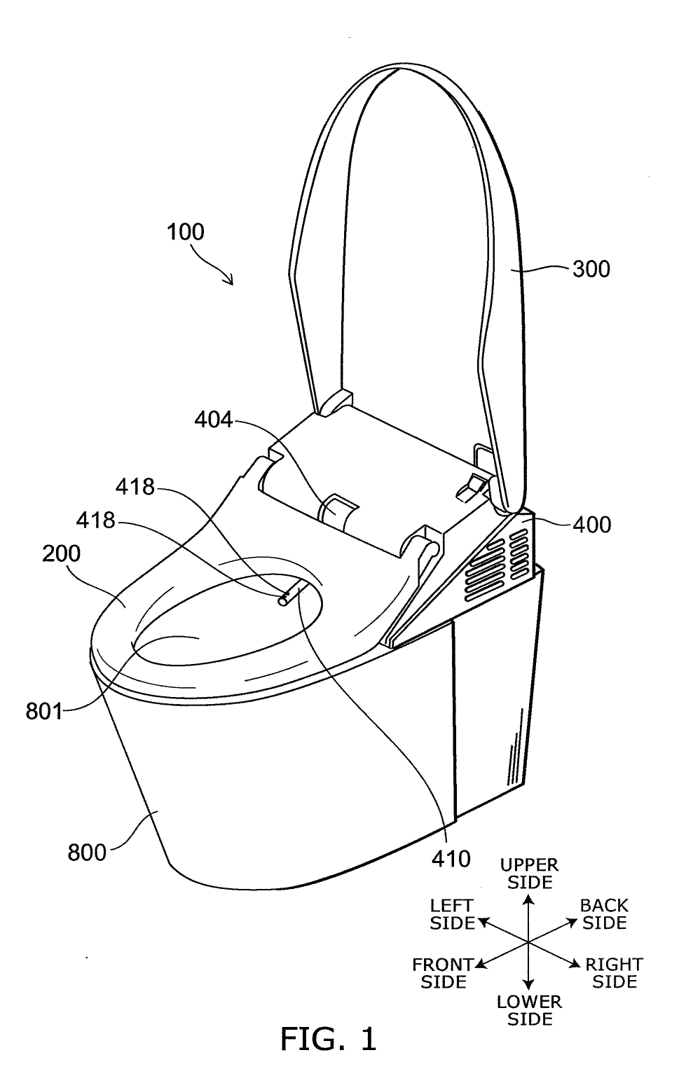

FIG. 1 is a schematic perspective view illustrating a toilet system including a sanitary washing apparatus according to an embodiment of the invention.

The toilet system illustrated in FIG. 1 includes a sit-down toilet stool (hereinafter simply referred to as “toilet stool” for convenience of description) 800 and a sanitary washing apparatus 100 provided thereon. The sanitary washing apparatus 100 includes a casing 400, a toilet seat 200, and a toilet lid 300. The toilet seat 200 and the toilet lid 300 are each pivotally supported on the casing 400 in an openable/closable manner.

A part washing functional unit that performs washing of a human body part of a user sitting on the toilet seat 200 and the like are installed in the casing 400. More specifically, a nozzle unit (not illustrated) capable of washing “the bottom” and the like of a user sitting on the toilet seat 200 are installed in the casing 400. The not-illustrated nozzle unit includes a washing nozzle 410 that jets out water supplied from, for example, a warm-water tank or the like toward “the bottom” and the like of a user.

Further, a seating detection sensor 404 that detects a user's sitting on the toilet seat 200, for example, is provided in the casing 400. In the case where the seating detection sensor 404 is detecting a user sitting on the toilet seat 200, the user can operate an operating unit, such as a not-illustrated remote control, to move the washing nozzle 410 into a bowl 801 of the toilet stool 800. FIG. 1 illustrates the sanitary washing apparatus 100 in a state in which the washing nozzle 410 has been moved into the bowl 801.

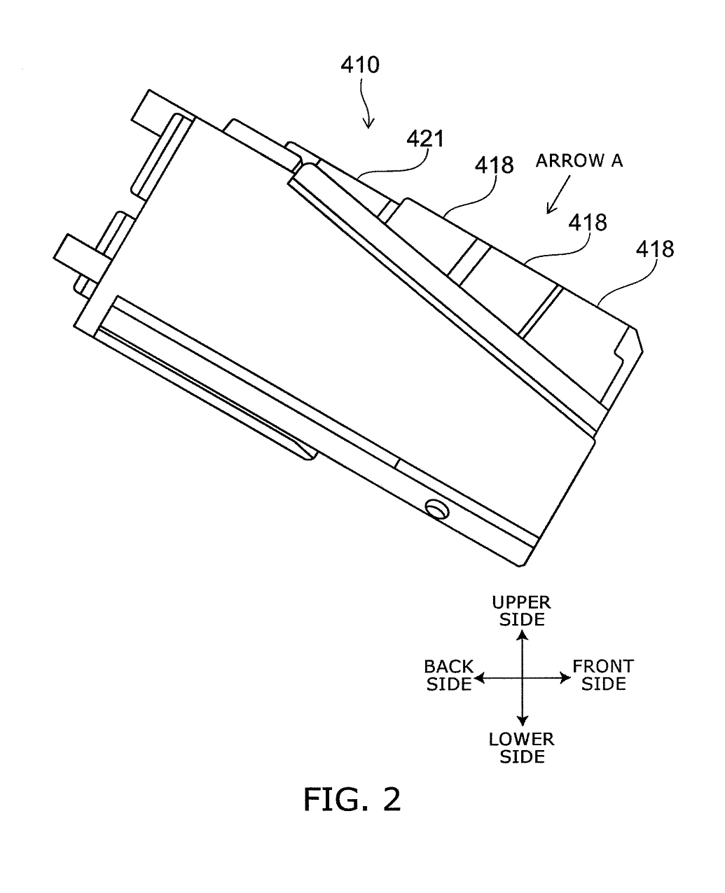

FIG. 2 is a schematic plan view of an end of the washing nozzle of this embodiment as viewed from side.

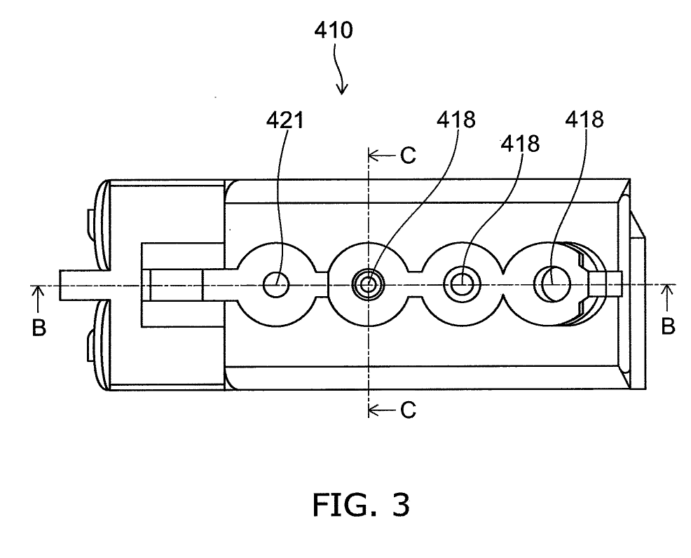

FIG. 3 is a schematic plan view of the end of the washing nozzle of this embodiment as viewed from the direction of arrow A illustrated in FIG. 2.

As illustrated in FIG. 2 and FIG. 3, one or a plurality of water discharge ports 418 are provided at the end of the washing nozzle 410. The washing nozzle 410 can jet out water through the water discharge port 418 provided at the end thereof to wash a human body part of a user sitting on the toilet seat 200. In the specification of this application, “water” includes not only cold water but also heated water. An air intake port 421 through which air can be taken into the washing nozzle 410 is provided at the end of the washing nozzle 410.

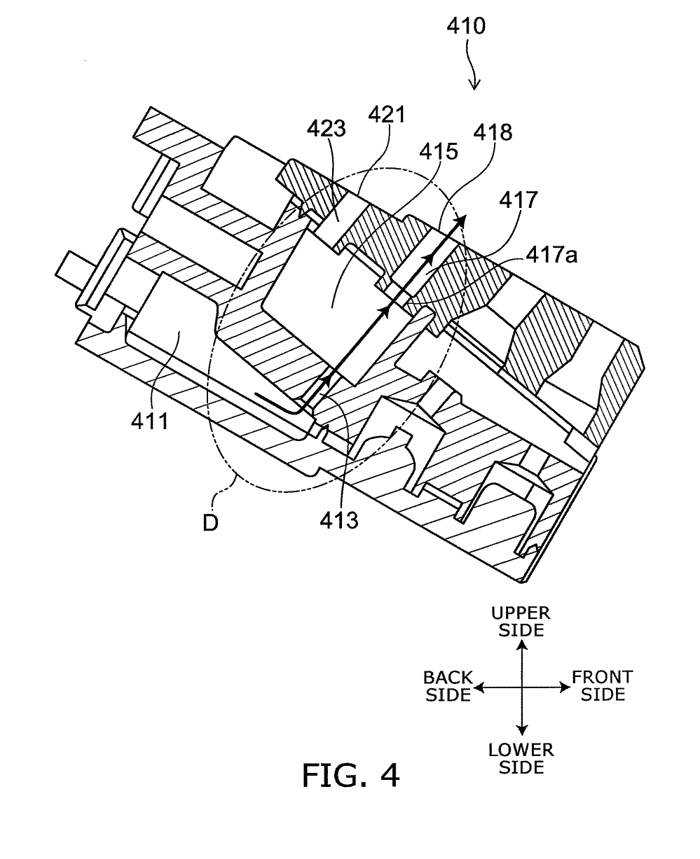

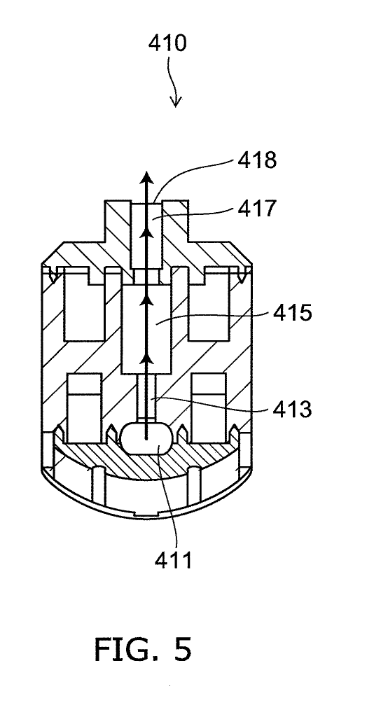

FIG. 4 and FIG. 5 are schematic cross-sectional views illustrating the inner structure of the washing nozzle of this embodiment.

FIG. 4 is a schematic cross-sectional view taken along cut plane B-B illustrated in FIG. 3.

FIG. 5 is a schematic cross-sectional view taken along cut plane C-C illustrated in FIG. 3.

A water supply path 411, an orifice 413, a mixing chamber 415, a throat 417, an air intake portion 423 are provided in the washing nozzle 410. The water supply path 411 is configured to pass wash water for washing a human body parts.

The flow of wash water in the washing nozzle 410 is outlined as follows. Wash water passed through the water supply path 411 passes through the orifice 413 into the mixing chamber 415 as indicated by the arrows illustrated in FIG. 4 and FIG. 5. Then, the water guided into the mixing chamber 415 passes through the throat 417 and is jetted out from the water discharge port 418 toward a human body part of a user sitting on the toilet seat 200. In other words, one end of the throat 417 functions as the water discharge port 418. The flow of wash water is described below.

The orifice 413 is connected to the water supply path 411 and can increase the flow speed of water supplied from the water supply path 411. The exit of the orifice 413 is directed to the human body part.

The mixing chamber 415 is connected with the exit of the orifice 413 and has a prescribed space. More specifically, as illustrated in FIG. 4 and FIG. 5, the area of the mixing chamber 415 in a cross section perpendicular to the discharge direction of wash water is larger than the area of the orifice 413 in a cross section perpendicular to the discharge direction of wash water.

The throat 417 is provided on a trajectory connecting the orifice 413 and the human body part. The entry of the throat 417 is connected with the mixing chamber 415. In other words, the mixing chamber 415 is provided on a downstream side of the orifice 413 and on an upstream side of the throat 417. The water supply path 411 and the mixing chamber 415 are connected via the orifice 413, and the mixing chamber 415 and the exterior of the washing nozzle 415 are connected via the throat 417. A narrowing projection 417a is provided near the entry of the throat 417, and the area of the exit of the throat 417 is larger than the area of the entry thereof, as illustrated in FIG. 4 and FIG. 5.

Further, the mixing chamber 415 and the exterior of the washing nozzle 410 are connected via the air intake portion 423. The air intake portion 423 can take air outside the washing nozzle 410 into the washing nozzle 410. At this time, one end of the air intake portion 423 functions as the air intake port 421. The flow of air taken into the mixing chamber 415 via the air intake portion 423 is described in detail later.

Next, the flow of wash water and the flow of air will now be described with reference to the drawings.

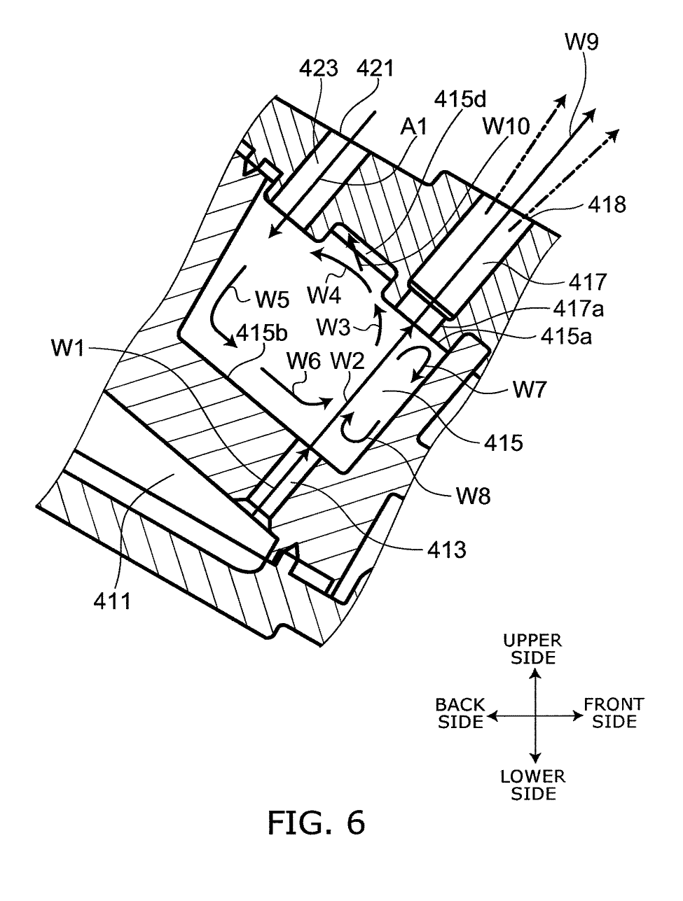

FIG. 6 is a schematic cross-sectional view for describing the flow of wash water in the washing nozzle of this embodiment.

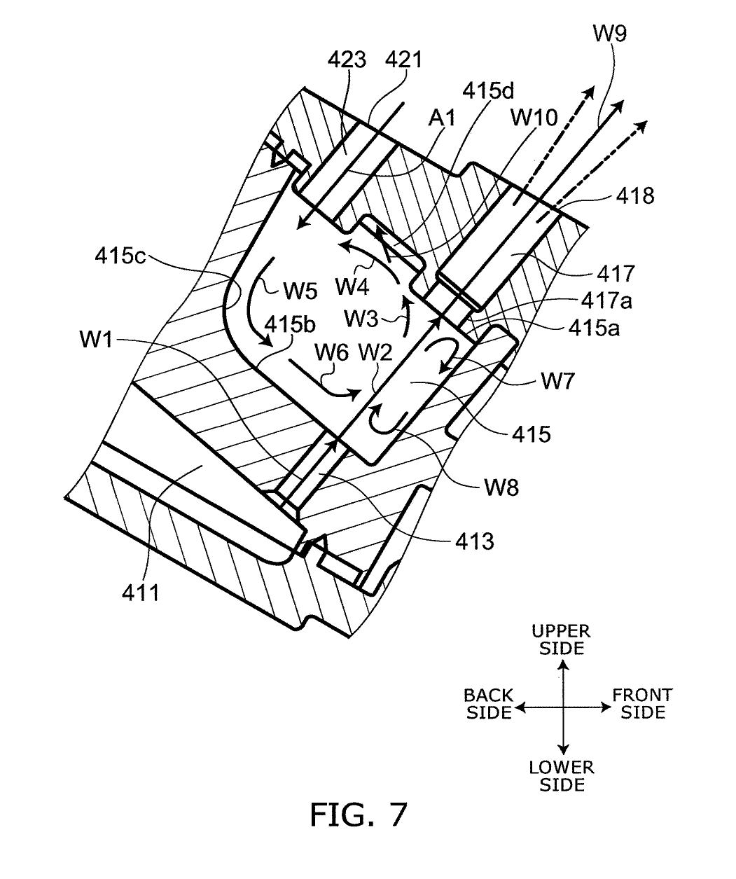

FIG. 7 is a schematic cross-sectional view for describing the flow of wash water in a washing nozzle according to a variation of this embodiment.

FIG. 6 and FIG. 7 are schematic enlarged views of region D illustrated in FIG. 4.

Wash water passed through inside the water supply path 411 passes through the orifice 413 into the mixing chamber 415 as indicated by arrow W1 illustrated in FIG. 6. Subsequently, the wash water guided into the mixing chamber 415 flows toward the entry of the throat 417. At this time, as described above regarding FIG. 4 and FIG. 5, the area of the mixing chamber 415 in a cross section perpendicular to the discharge direction of wash water is larger than the area of the orifice 413 in a cross section perpendicular to the discharge direction of wash water. The change in cross-sectional area causes a negative pressure in the mixing chamber 415, giving rise to a disorder in the jet flow of the wash water that has passed through the orifice 413 and been introduced into the mixing chamber 415.

The disorder of the jet flow divides the wash water flowing toward the entry of the throat 417 into wash water that passes through the throat 417, as indicated by arrow W2 illustrated in FIG. 6, and wash water whose flow direction is changed by a wall face 415a of the mixing chamber 415, as indicated by arrows W3 and W7 illustrated in FIG. 6. As a consequence, compulsory convection flowing in certain directions is generated in the mixing chamber 415, as indicated by arrows W3 to W8 illustrated in FIG. 6, by the wash water whose flow direction is changed by the wall face 415a of the mixing chamber 415 and the wash water flowing from the orifice 413 toward the throat 417.

The convection and the wash water flowing from the orifice 413 toward the throat 417 causes a negative pressure in the mixing chamber 415. Therefore, air outside the washing nozzle 410 is sucked into the mixing chamber 415 via the air intake portion 423 as indicated by arrow A1 illustrated in FIG. 6. As a consequence, the air sucked into the mixing chamber 415 is mixed into the wash water of the convection generated in the mixing chamber 415 as air bubbles and flows along with the convection.

The wash water mixed with air comes close to the wash water flowing from the orifice 413 toward the throat 417 as indicated by arrows W6 and W8 illustrated in FIG. 6. Here, a negative pressure is generated around the wash water flowing from the orifice 413 toward the throat 417. Accordingly, at least part of the wash water mixed with air is drawn into and joins the wash water flowing from the orifice 413 toward the throat 417. Then, the joined wash water flows toward the entry of the throat 417, with air therein. In other words, the compulsory convection generated in the mixing chamber 415 forms a return flow that once separates from the wash water flowing from the orifice 413 toward the throat 417, then takes in air, and then joins the wash water.

Here, the air intake portion 423 is provided in a position away from the orifice 413 and the throat 417 as illustrated in FIG. 6. Therefore, air sucked into the mixing chamber 415 flows into the mixing chamber 415 in a position away from the wash water flowing from the orifice 413 toward the throat 417. The air flowing into the mixing chamber 415 is mixed into the return flow as air bubbles, as described above.

Therefore, the air sucked into the mixing chamber 415 is mixed into the return flow with limited influence of disorder of the jet flow of the wash water flowing from the orifice 413 toward the throat 417. Accordingly, the air sucked into the mixing chamber 415 is mixed into the return flow in a more stable state. Consequently, the air sucked into the mixing chamber 415 and the return flow are mixed together more efficiently. Thus, more air is mixed into the return flow.

Furthermore, as illustrated in FIG. 6, the air intake portion 423 is formed to run along the flow of the return flow in the upper end portion of the mixing chamber 415. Therefore, air to be sucked into the mixing chamber 415 is sucked and flows to run along the flow of the return flow. Consequently, the air sucked into the mixing chamber 415 flows into the mixing chamber 415 more efficiently and is mixed into the return flow more efficiently. Thus, more air is mixed into the return flow.

In the invention, the air intake portion 423 may be provided in another position in the mixing chamber 415, not limited to the upper end portion of the mixing chamber 415. However, the direction of the air intake portion 423 is preferably directed in the tangent direction of the return flow. This makes it difficult for the return flow to flow out through the air intake portion 423, and offers no obstruction to the suction of air into the mixing chamber 415. Thus, air can be mixed into the return flow similarly efficiently.

Furthermore, as illustrated in FIG. 6, the orifice 413 and the throat 417 are provided not in the central portion but in an end portion of the mixing chamber 415 as viewing a cross section perpendicular to the discharge direction of wash water. Accordingly, the wash water flowing from the orifice 413 toward the throat 417 passes through the end portion of the mixing chamber 415. This ensures a larger space in which the return flow is generated. Therefore, the return flow is formed larger in the mixing chamber 415. Furthermore, the mixing chamber 415 has a space large enough to allow the return flow to be formed larger. More specifically, the distance between the wall face 415a and a wall face 415b of the mixing chamber 415 is large enough to allow the return flow to be formed larger. Therefore, there are fewer occasions when pieces of air mixed in with the return flow come into contact with each other, and the air is kept in a state of fine air bubbles. Consequently, the air sucked into the mixing chamber 415 and the return flow are mixed together more efficiently. Thus, more air is mixed into the return flow.

Moreover, as illustrated in FIG. 6, a recess 415d is formed in at least part of the wall face 415a of the mixing chamber 415 of this embodiment. By forming the recess 415d, air outside the washing nozzle 410 can be sucked more stably into the mixing chamber 415 via the air intake portion 423.

A more specific description is given as follows. At least part of wash water whose flow direction is changed by the wall face 415a of the mixing chamber 415 and flowing toward the air intake portion 423 goes toward the recess 415d as indicated by arrow W10 illustrated in FIG. 6. The flow direction of wash water going toward the recess 415d is changed to the lower portion of the mixing chamber 415 by the recess 415d. The wash water whose flow direction is changed to the lower portion of the mixing chamber 415 does not flow toward the opening of the air intake portion 423 in the mixing chamber 415. This decreases the possibility that the opening of the air intake portion 423 in the mixing chamber 415 may be blocked by wash water. Thereby, air outside the washing nozzle 410 is sucked more stably into the mixing chamber 415 via the air intake portion 423.

In other words, water flowing not along the return flow may prevent air from being sucked via the air intake portion 423. The flow direction of the water is changed by the contact with the recess 415d. This creates a situation in which air is easily sucked via the air intake portion 423. Thereby, air outside the washing nozzle 410 is sucked more stably into the mixing chamber 415 via the air intake portion 423.

Thus, the recess 415d changes the flow of the return flow to prevent the opening in the mixing chamber 415 from being blocked by water, and thereby mixing of air can be stably supplied near the air intake portion 423 by a negative pressure due to the return flow. This enables more air to be mixed into the return flow as air bubbles. Furthermore, the recess 415d can ensure a larger space in which the return flow is generated. Therefore, there are fewer occasions when pieces of air mixed in with the return flow come into contact with each other, and the air is kept in a state of fine air bubbles. Consequently, the air sucked into the mixing chamber 415 and the return flow are mixed together more efficiently. Thus, more air is mixed into the return flow.

The means for generating a negative pressure due to the return flow more stably is not limited to the recess 415d. It is sufficient that the means for generating a negative pressure due to the return flow more stably has a structure not inhibiting generation of a negative pressure. For example, a rib provided at the opening on the mixing chamber 415 side of the air intake portion 423 may be used.

In this embodiment, the air intake portion 423 is placed in the upper end portion of the mixing chamber 415. This facilitates ensuring a region with no water near the air intake portion 423 of the mixing chamber 415. Thereby, since air easily enters the mixing chamber 415, the air is mixed efficiently into the mixing chamber 415.

Here, in the case where, for example, the mixing chamber 415 has a curved surface 415c formed by a larger radius as illustrated in FIG. 7, wash water including air is difficult to attenuate. Therefore, in the case where the mixing chamber 415 has a shape configured to reduce attenuation of wash water including air, the flow of the wash water is easily maintained and is less likely to become slow. As a consequence, the air sucked into the mixing chamber 415 and the return flow are mixed together yet more efficiently. Thus, yet more air is mixed into the return flow.

Referring to FIG. 6 again, the return flow mixed with air joins the wash water flowing from the orifice 413 toward the throat 417 and passes through the throat 417 as indicated by arrows W2 and W9 illustrated in FIG. 6. Here, a portion containing a larger amount of air mixed in wash water as air bubbles contains a smaller amount of water mixed in the mixing chamber 415. Therefore, the speed of the wash water in the portion is higher. On the other hand, a portion containing a smaller amount of air mixed in wash water as air bubbles contains a larger amount of water mixed in the mixing chamber 415. Therefore, the speed of the wash water in the portion is lower. This gives rise to a repetition of a high-speed portion and a low-speed portion in wash water discharged from the water discharge port 418. In other words, a speed difference is caused between points of the wash water discharged from the water discharge port 418.

Otherwise, when wash water mixed with air passes through the throat 417, since the narrowing projection 417a is provided at the throat 417 on the mixing chamber 415 side, a negative pressure is generated in the throat 417 by the flow of the confluent water of the water to be jetted out from the throat 417 and the return flow mixed with air bubbles after the confluent water passes the narrowing projection 417a. The negative pressure in the jet hole causes a repeated movement of the water flow being drawn to the inner wall of the throat 417. Accordingly, water discharged from the throat 417 is discharged while oscillating with a central focus on the discharge direction thereof. Therefore, the discharged water can be turned into a droplet state at early stage, allowing to provide a high feeling of stimulation. Furthermore, the oscillation can widen the washing area.

Due to such disorder of the jet flow, the wash water passing through the throat 417 and the wash water discharged from the water discharge port 418 oscillate as indicated by the alternate long and two short dashes lines illustrated in FIG. 6.

Furthermore, due to such disorder of the jet flow and mixing of air, the wash water passing through the throat 417 and the wash water discharged from the water discharge port 418 become thin or thick. The repetition of thinness and thickness of wash water causes a repetition of a high-speed portion and a low-speed portion in the wash water discharged from the water discharge port 418. In other words, a speed difference is caused between points of the wash water discharged from the water discharge port 418. The speed difference gives rise to a repetition of condensation and rarefaction of wash water as a natural variation.

Otherwise, as described above, the negative pressure generated in the mixing chamber 415 causes air outside the washing nozzle 410 to be sucked into the mixing chamber 415 via the air intake portion 423. As a consequence, the interior of the mixing chamber 415 changes from a negative pressure to a positive pressure. At this time, since wash water continuously flows from the orifice 413 toward the throat 417, a negative pressure is generated again in the mixing chamber 415. Such a repetition of increase and decrease of the pressure in the mixing chamber 415 causes a repetition of a high-speed portion and a low-speed portion in the wash water discharged from the water discharge port 418. In other words, a speed difference is caused between points of the wash water discharged from the water discharge port 418.

Owing to the oscillation and speed difference of the jet flow of wash water, the wash water discharged from the water discharge port 418 changes from a continuous flow to a droplet state at early stage after water discharge.

Furthermore, since water-saving efficiency can be increased, electric power for heating the water in a warm-water tank, for example, can be reduced to decrease standby power. Therefore, energy saving can be accomplished. Furthermore, since water-saving efficiency can be increased, an instantaneous-heating heat exchanger that can heat supplied water instantaneously into prescribed warm water can be used, instead of a warm-water tank. This can further accomplish energy saving.

Furthermore, according to this embodiment, liquid drops are formed in wash water discharged from the water discharge port 418. Therefore, the portion of liquid drops of wash water can land on a human body part, allowing to provide a feeling of volume. Here, in the specification of this application, the “feeling of volume” refers to being hit by discharged water having a large water discharge cross-sectional area (weight) and a sufficient force, in other words, a feeling of contacting a thick water flow. Generally, the larger the water landing area of discharged water is, the more a user feels a feeling of volume.

Moreover, when the portion of liquid drops of wash water lands on a human body part, the human body part has a larger load. The interval of the time when the portion of liquid drops of wash water lands on the human body part, that is, the time interval of the repetition of condensation and rarefaction of wash water, is short enough for the human body not to sense. Therefore, the user feels as if liquid drops hit the human body part continuously. Thus, a feeling of stimulation can be provided. Here, in the specification of this application, the “feeling of stimulation” refers to rapid discharged water hitting a human body part, in other words, a feeling of stimulation close to a pain. The feeling of stimulation depends on the flow speed.

Therefore, this embodiment can maintain a feeling of washing even if the flow rate of wash water is reduced, while increasing water-saving efficiency and reducing standby power. The feeling of washing is a feeling expressed by the feeling of volume and the feeling of stimulation described above.

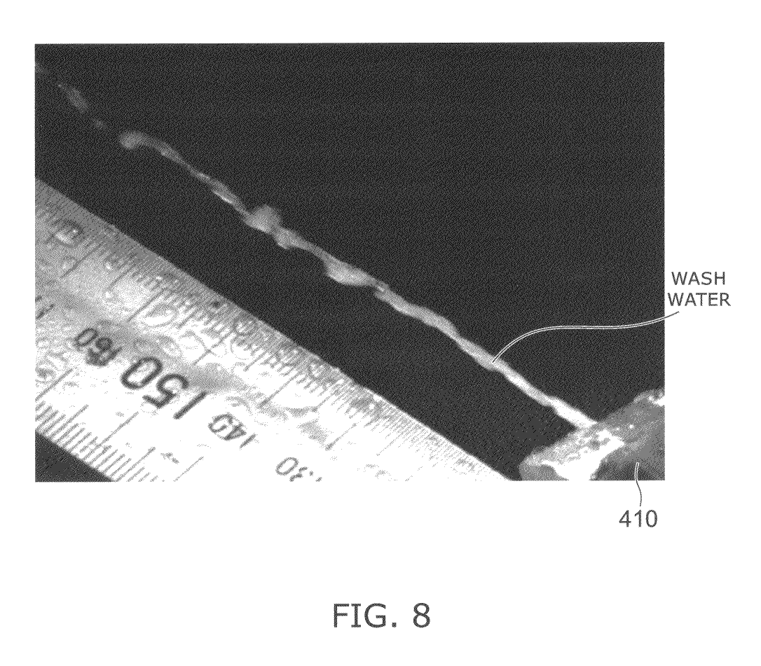

FIG. 8 is a photograph illustrating an example of the wash water discharged from a washing nozzle of this embodiment.

The inventors verified the water discharge state using the washing nozzle of this embodiment formed with a mold. FIG. 8 shows a photograph of an example of the water discharge state. Generally, a human body part of a user sitting on the toilet seat 200 exists in a position away from the water discharge port 418 of the washing nozzle 410 by about 50 millimeters, for example. Therefore, the human body part of the user sitting on the toilet seat 200 exists near a position corresponding to the value “150” shown in FIG. 8.

According to the water discharge state shown in FIG. 8, it is found out that liquid drops of wash water are formed near the position (the position corresponding to the value “150” shown in FIG. 8) in which it is assumed that the human body part of the user sitting on the toilet seat 200 exists. Furthermore, according to the water discharge state shown in FIG. 8, a lot of air is mixed in the wash water discharged from the water discharge port 418 as air bubbles.

According to this embodiment as described above, a lot of air can be mixed into wash water jetted out from the water discharge port 418 toward a human body part; therefore, water-saving efficiency can be increased more. Furthermore, since water-saving efficiency can be increased, standby power can be reduced. Therefore, energy saving can be accomplished. Furthermore, liquid drops are formed in wash water discharged from the water discharge port 418. Therefore, the portion of liquid drops of wash water can land on a human body part to provide a feeling of volume. Moreover, when the portion of liquid drops of wash water lands on a human body part, the human body part has a larger load. This can provide a feeling of stimulation. Therefore, a feeling of washing can be maintained even if the flow rate of wash water is reduced, while increasing water-saving efficiency and reducing standby power.

Hereinabove, embodiments of the invention are described. However, the invention is not limited to these descriptions. One skilled in the art may perform appropriately design modifications on the embodiments described above. Such modifications also are included in the scope of the invention to the extent that the purport of the invention is included. For example, the shape, dimension, material, arrangement, and the like of components of the washing nozzle 410 and the like, the installation configuration of the orifice 413, the mixing chamber 415, and the throat 417, and the like are not limited to those illustrated but may be appropriately altered.

Furthermore, components of the embodiments described above may be combined within the extent of technical feasibility; and combinations of them also are included in the scope of the invention to the extent that the purport of the invention is included.

1. A sanitary washing apparatus comprising a washing nozzle configured to discharge wash water toward a human body part,
the washing nozzle including:
a water supply path configured to pass the wash water;
an orifice configured to direct the wash water passed through the water supply path toward the human body part;
a throat provided on a trajectory connecting the orifice and the human body part;
a mixing chamber provided on a downstream side of the orifice and on an upstream side of the throat, an area of a cross section of the mixing chamber perpendicular to a discharge direction of the wash water being larger than an area of a cross section of the orifice perpendicular to the discharge direction; and
an air intake portion configured to take air into the mixing chamber by a negative pressure generated by wash water flowing from the orifice toward the throat,
a return flow being generated in the mixing chamber by wash water flowing out from the orifice and having a flow direction changed by a wall face of the mixing chamber,
the air sucked into the mixing chamber via the air intake portion being mixed into the return flow as an air bubble,
the return flow mixed with the air joining wash water flowing from the orifice toward the throat and being discharged from the throat.

2. The apparatus according to claim 1, wherein a repetition of increase and decrease in pressure is caused in the mixing chamber by a negative pressure generated by wash water flowing from the orifice toward the throat and the air sucked into the mixing chamber via the air intake portion.

3. The apparatus according to claim 1, wherein the orifice and the throat are provided in an end portion of the mixing chamber as viewing a cross section perpendicular to the discharge direction of the wash water.

4. The apparatus according to claim 1, wherein the air intake portion is provided in a position away from the orifice and the throat.

5. The apparatus according to claim 1, wherein
the air intake portion is formed to run along a flow of the return flow, and
the air sucked via the air intake portion flows into the mixing chamber to run along the flow of the return flow.

6. The apparatus according to claim 1, wherein the mixing chamber has a shape configured to reduce attenuation of wash water including the air.

7. The apparatus according to claim 1, wherein a narrowing projection configured to narrow a flow path area of the throat is provided at the throat.
